(19) United States
(12) Patent Application Publication
(10) Pub. No.: US 2024/0346628 A1
(43) Pub. Date: Oct. 17, 2024

(54) SYSTEMS AND METHODS FOR MOTION CORRECTION FOR A MEDICAL IMAGE

(71) Applicant: SHANGHAI UNITED IMAGING HEALTHCARE CO., LTD., Shanghai (CN)

(72) Inventor: Peng WANG, Shanghai (CN)

(73) Assignee: SHANGHAI UNITED IMAGING HEALTHCARE CO., LTD., Shanghai (CN)

(21) Appl. No.: 18/757,401

(22) Filed: Jun. 27, 2024

Related U.S. Application Data
(63) Continuation of application No. PCT/CN2021/143693, filed on Dec. 31, 2021.

(51) Int. Cl. G06T 5/70; G06T 5/50

(52) U.S. Cl. CPC G06T 5/70; G06T 5/50; G06T 2207/20081; G06T 2207/30048; G06T 2207/30101

(57) ABSTRACT

Systems and methods for motion correction for a medical image. The systems may obtain a plurality of training samples each of which includes a sample image of a heart and a gold standard image of the heart. The sample image may have a motion artifact and the gold standard image may be with substantial removal of the motion artifact. The systems may also determine a motion correction model by training, based on the plurality of training samples according to a combined loss function, a preliminary model. The combined loss function may include at least a local loss function.

### CROSS-REFERENCE TO RELATED APPLICATIONS

This application is a Continuation of International Application No. PCT/CN2021/143693, filed on Dec. 31, 2021, and the contents of which are hereby incorporated by reference.

### TECHNICAL FIELD

The present disclosure generally relates to medical image processing, and more particularly, relates to systems and methods for motion correction for a medical image.

### BACKGROUND

Medical imaging techniques (e.g., computed tomography (CT), magnetic resonance imaging (MRI), positron emission tomography (PET), single-photon emission computed tomography (SPECT), etc.) are widely used in clinical diagnosis and/or treatment. The quality of images generated in a medical imaging process has a significant influence on disease diagnosis and/or treatment. Motion artifacts often exist in images of coronary arteries of the heart of a patient since the heart beats ceaselessly. Thus, it is desirable to provide a system and method for correcting motion artifacts in medical images effectively and accurately.

### SUMMARY

In one aspect of the present disclosure, a system for motion correction is provided. The system may include at least one storage device including a set of instructions, and at least one processor configured to communicate with the at least one storage device. When executing the set of instructions, the at least one processor may be configured to direct the system to perform the following operations. The at least one processor may obtain a plurality of training samples each of which includes a sample image of a heart and a gold standard image of the heart. The sample image may have a motion artifact and the gold standard image may be with substantial removal of the motion artifact. The at least one processor may also determine a motion correction model by training, based on the plurality of training samples according to a combined loss function, a preliminary model. The combined loss function may include at least a local loss function.

In some embodiments, the determining a motion correction model by training, based on the plurality of training samples according to a combined loss function, a preliminary model may include training the preliminary model according to an iterative operation including one or more iterations. In at least one of the one or more iterations, the at least one processor may be configured to direct the system to further perform the operations. The at least one processor may obtain an updated preliminary model generated in a previous iteration. For the each of the plurality of training samples, the at least one processor may generate, based on the sample image, an estimated corrected image using the updated preliminary model; determine a value of the combined loss function based on the estimated corrected image and the gold standard image; and updating, based on the value of the combined loss function, the updated preliminary model, or designating, based on the value of the combined loss function, the updated preliminary model as the motion correction model.

In some embodiments, the at least one processor may be configured to direct the system to perform the operations further: extracting a centerline of a coronary artery from the gold standard image; determining a mask by performing an expansion operation on the centerline; and determining a value of the local loss function based on the mask, the estimated corrected image, and the gold standard image.

In some embodiments, the determining a value of the local loss function based on the mask, the estimated corrected image, and the gold standard image may include determining, in the estimated corrected image, a first local region corresponding to the coronary artery based on the mask and the estimated corrected image; determining, in the gold standard image, a second local region corresponding to the coronary artery based on the mask and the gold standard image; and determining the value of the local loss function based on a difference between the first local region and the second local region.

In some embodiments, the combined loss function may further include a dice related loss function.

In some embodiments, the at least one processor may be configured to direct the system to perform the operations further including determining a first coronary artery from the estimated corrected image; determining a second coronary artery from the gold standard image; and determining a value of the dice related loss function based on the first coronary artery and the second coronary artery.

In some embodiments, the combined loss function may further include a global loss function.

In some embodiments, the at least one processor may be configured to direct the system to perform the operations further including determining a value of the global loss function based on the estimated corrected image and the gold standard image.

In some embodiments, the at least one processor may be configured to direct the system to perform the operations further including determining a value of the combined loss function by a weighted sum of a value of the local loss function, a value of the dice related loss function, and a value of the global loss function.

In some embodiments, a first significance of the local loss function may be higher than a second significance of the dice related loss function, and the second significance of the dice related loss function may be higher than a third significance of the global loss function.

In some embodiments, the determining a value of the combined loss function by a weighted sum of a value of the local loss function, a value of the dice related loss function, and a value of the global loss function may include performing a preprocessing operation on the value of the local loss function, the value of the dice related loss function, and the value of the global loss function respectively, such that the preprocessed value of the local loss function, the preprocessed value of the dice function, and the preprocessed value of the global loss function may be in a same order of magnitude; and determining the value of the combined loss function by a weighted sum of the preprocessed value of the local loss function, the preprocessed value of the dice related loss function, and the preprocessed value of the global loss function.

In some embodiments, the preprocessing operation may include enlarging at least one of the value of the local loss function or the value of the dice related loss function.

In some embodiments, the at least one processor may be configured to direct the system to perform the operations further including obtaining a plurality of corrected images of an initial image; obtaining a gold standard image corresponding to the initial image; and determining the combined loss function based on the plurality of corrected images and the gold standard image.

In some embodiments, the determining the combined loss function based on the plurality of corrected images and the gold standard image may include determining a reference rank result by ranking the plurality of corrected images; obtaining an initial loss function; determining an evaluated rank result by ranking, based on the initial loss function and the gold standard image, the plurality of corrected images; and determining the combined loss function by adjusting the initial loss function until an updated evaluated rank result substantially coincides with the reference rank result.

In another aspect of the present disclosure, a method for motion correction is provided. The method may be implemented on a computing device including at least one processor and at least one storage device. The method may include obtaining a plurality of training samples each of which includes a sample image of a heart and a gold standard image of the heart. The sample image may have a motion artifact and the gold standard image may be with substantial removal of the motion artifact. The method may also include determining a motion correction model by training, based on the plurality of training samples according to a combined loss function, a preliminary model. The combined loss function may include at least a local loss function.

In some embodiments, the determining a motion correction model by training, based on the plurality of training samples according to a combined loss function, a preliminary model may include training the preliminary model according to an iterative operation including one or more iterations. In at least one of the one or more iterations, the method may further include obtaining an updated preliminary model generated in a previous iteration. For the each of the plurality of training samples, the method may further include generating, based on the sample image, an estimated corrected image using the updated preliminary model; determining a value of the combined loss function based on the estimated corrected image and the gold standard image; and updating, based on the value of the combined loss function, the updated preliminary model, or designating, based on the value of the combined loss function, the updated preliminary model as the motion correction model.

In some embodiments 16, the method may further include extracting a centerline of a coronary artery from the gold standard image; determining a mask by performing an expansion operation on the centerline; and determining a value of the local loss function based on the mask, the estimated corrected image, and the gold standard image.

In some embodiments, the determining a value of the local loss function based on the mask, the estimated corrected image, and the gold standard image may include determining, in the estimated corrected image, a first local region corresponding to the coronary artery based on the mask and the estimated corrected image; determining, in the gold standard image, a second local region corresponding to the coronary artery based on the mask and the gold standard image; and determining the value of the local loss function based on a difference between the first local region and the second local region.

In some embodiments, the combined loss function may further include a dice related loss function.

In some embodiments, the method may further include determining a first coronary artery from the estimated corrected image; determining a second coronary artery from the gold standard image; and determining a value of the dice related loss function based on the first coronary artery and the second coronary artery.

In some embodiments, the combined loss function may further include a global loss function.

In some embodiments, the method may further include determining a value of the global loss function based on the estimated corrected image and the gold standard image.

In some embodiments, the method may further include determining a value of the combined loss function by a weighted sum of a value of the local loss function, a value of the dice related loss function, and a value of the global loss function.

In some embodiments, a first significance of the local loss function may be higher than a second significance of the dice related loss function, and the second significance of the dice related loss function may be higher than a third significance of the global loss function.

In some embodiments, the determining a value of the combined loss function by a weighted sum of a value of the local loss function, a value of the dice related loss function, and a value of the global loss function may include performing a preprocessing operation on the value of the local loss function, the value of the dice related loss function, and the value of the global loss function respectively, such that the preprocessed value of the local loss function, the preprocessed value of the dice function, and the preprocessed value of the global loss function may be in a same order of magnitude; and determining the value of the combined loss function by a weighted sum of the preprocessed value of the local loss function, the preprocessed value of the dice related loss function, and the preprocessed value of the global loss function.

In some embodiments, the preprocessing operation may include enlarging at least one of the value of the local loss function or the value of the dice related loss function.

In some embodiments, the method may further include obtaining a plurality of corrected images of an initial image; obtaining a gold standard image corresponding to the initial image; and determining the combined loss function based on the plurality of corrected images and the gold standard image.

In some embodiments, the determining the combined loss function based on the plurality of corrected images and the gold standard image may include determining a reference rank result by ranking the plurality of corrected images; obtaining an initial loss function; determining an evaluated rank result by ranking, based on the initial loss function and the gold standard image, the plurality of corrected images; and determining the combined loss function by adjusting the initial loss function until an updated evaluated rank result substantially coincides with the reference rank result.

In another aspect of the present disclosure, a system for motion correction is provided. The system may include an obtaining module and a training module. The obtaining module may be configured to obtain a plurality of training samples each of which includes a sample image of a heart and a gold standard image of the heart. The sample image may have a motion artifact and the gold standard image may be with substantial removal of the motion artifact. The training module may be configured to determine a motion correction model by training, based on the plurality of training samples according to a combined loss function, a preliminary model. The combined loss function may include at least a local loss function.

In another aspect of the present disclosure, a non-transitory computer readable medium is provided. The non-transitory computer readable medium may include executable instructions that, when executed by at least one processor, direct the at least one processor to perform a method for motion correction. The method may include obtaining a plurality of training samples each of which includes a sample image of a heart and a gold standard image of the heart. The sample image may have a motion artifact and the gold standard image may be with substantial removal of the motion artifact. The method may also include determining a motion correction model by training, based on the plurality of training samples according to a combined loss function, a preliminary model. The combined loss function may include at least a local loss function.

In another aspect of the present disclosure, a system for correction effect evaluation is provided. The system may include at least one storage device including a set of instructions, and at least one processor configured to communicate with the at least one storage device. When executing the set of instructions, the at least one processor may be configured to direct the system to perform the following operations. The at least one processor may correct an initial image using a correction algorithm to obtain a corrected image. The at least one processor may also obtain a gold standard image corresponding to the initial image. The at least one processor may further evaluate a correction effect of the correction algorithm based on a combined loss function associated with the corrected image and the gold standard image. The combined loss function may include at least a local loss function associated with a first local region of the corrected image and a second local region of the gold standard image.

In some embodiments, the first local region and the second local region may include a coronary artery.

In some embodiments, the at least one processor may be configured to direct the system to perform the operations further including extracting a centerline of the coronary artery from the gold standard image; determining a mask by performing an expansion operation on the centerline; determining the first local region of the corrected image based on the mask and the corrected image; determining the second local region of the gold standard image based on the mask and the gold standard image, and determining a value of the local loss function based on a difference between the first local region and the second local region.

In some embodiments, the combined loss function may further include a dice related loss function.

In some embodiments, the at least one processor may be configured to direct the system to perform the operations further including determining a first coronary artery from the corrected image; determining a second coronary artery from the gold standard image; and determining a value of the dice related loss function based on the first coronary artery and the second coronary artery.

In some embodiments, the combined loss function may further include a global loss function.

In some embodiments, the at least one processor may be configured to direct the system to perform the operations further including determining a value of the global loss function based on the corrected image and the gold standard image.

In some embodiments, the at least one processor may be configured to direct the system to perform the operations further including determining a value of the combined loss function by a weighted sum of a value of the local loss function, a value of the dice related loss function, and a value of the global loss function.

In some embodiments, a first weight of the local loss function may be larger than a second weight of the dice related loss function, and the second weight of the dice related loss function may be larger than a third weight of the global loss function.

In some embodiments, the determining a value of the combined loss function by a weighted sum of a value of the local loss function, a value of the dice related loss function, and a value of the global loss function may include performing a preprocessing operation on the value of the local loss function, the value of the dice related loss function, and the value of the global loss function respectively, such that the preprocessed value of the local loss function, the preprocessed value of the dice function, and the preprocessed value of the global loss function may be in a same order of magnitude; and determining the value of the combined loss function by a weighted sum of the preprocessed value of the local loss function, the preprocessed value of the dice related loss function, and the preprocessed value of the global loss function.

In some embodiments, the evaluating a correction effect of the correction algorithm based on a combined loss function associated with the corrected image and the gold standard image may include mapping a value of the combined loss function to an evaluation value; and evaluating the correction effect of the correction algorithm according to the evaluation value.

In some embodiments, the correction algorithm may include at least one of a motion vector field correction algorithm, a raw data correction algorithm, or an artificial intelligence correction algorithm.

In another aspect of the present disclosure, a method for correction effect evaluation is provided. The method may be implemented on a computing device including at least one processor and at least one storage device. The method may include correcting an initial image using a correction algorithm to obtain a corrected image. The method may also include obtaining a gold standard image corresponding to the initial image. The method may further include evaluating a correction effect of the correction algorithm based on a combined loss function associated with the corrected image and the gold standard image. The combined loss function may include at least a local loss function associated with a first local region of the corrected image and a second local region of the gold standard image.

In some embodiments, the first local region and the second local region may include a coronary artery.

In some embodiments, the method may further include extracting a centerline of the coronary artery from the gold standard image; determining a mask by performing an expansion operation on the centerline; determining the first local region of the corrected image based on the mask and the corrected image; determining the second local region of the gold standard image based on the mask and the gold standard image; and determining a value of the local loss function based on a difference between the first local region and the second local region.

In some embodiments, the combined loss function may further include a dice related loss function.

In some embodiments, the method may further include determining a first coronary artery from the corrected image; determining a second coronary artery from the gold standard image; and determining a value of the dice related loss function based on the first coronary artery and the second coronary artery.

In some embodiments, the combined loss function may further include a global loss function.

In some embodiments, the method may further include determining a value of the global loss function based on the corrected image and the gold standard image.

In some embodiments, the method may further include determining a value of the combined loss function by a weighted sum of a value of the local loss function, a value of the dice related loss function, and a value of the global loss function.

In some embodiments, a first weight of the local loss function may be larger than a second weight of the dice related loss function, and the second weight of the dice related loss function may be larger than a third weight of the global loss function.

In some embodiments, the determining a value of the combined loss function by a weighted sum of a value of the local loss function, a value of the dice related loss function, and a value of the global loss function may include performing a preprocessing operation on the value of the local loss function, the value of the dice related loss function, and the value of the global loss function respectively, such that the preprocessed value of the local loss function, the preprocessed value of the dice function, and the preprocessed value of the global loss function may be in a same order of magnitude; and determining the value of the combined loss function by a weighted sum of the preprocessed value of the local loss function, the preprocessed value of the dice related loss function, and the preprocessed value of the global loss function.

In some embodiments, the evaluating a correction effect of the correction algorithm based on a combined loss function associated with the corrected image and the gold standard image may include mapping a value of the combined loss function to an evaluation value; and evaluating the correction effect of the correction algorithm according to the evaluation value.

In some embodiments, the correction algorithm may include at least one of a motion vector field correction algorithm, a raw data correction algorithm, or an artificial intelligence correction algorithm.

In another aspect of the present disclosure, a system for correction effect evaluation is provided. The system may include an obtaining module and an evaluation module. The obtaining module may be configured to obtain a corrected image by correcting an initial image using a correction algorithm; and obtain a gold standard image corresponding to the initial image. The evaluation module may be configured to evaluate a correction effect of the correction algorithm based on a combined loss function associated with the corrected image and the gold standard image. The combined loss function may include at least a local loss function associated with a first local region of the corrected image and a second local region of the gold standard image.

In another aspect of the present disclosure, a non-transitory computer readable medium is provided. The non-transitory computer readable medium may include executable instructions that, when executed by at least one processor, direct the at least one processor to perform a method for correction effect evaluation. The method may include correcting an initial image using a correction algorithm to obtain a corrected image. The method may also include obtaining a gold standard image corresponding to the initial image. The method may further include evaluating a correction effect of the correction algorithm based on a combined loss function associated with the corrected image and the gold standard image. The combined loss function may include at least a local loss function associated with a first local region of the corrected image and a second local region of the gold standard image.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary medical imaging system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device according to some embodiments of the present disclosure;

FIGS. 4A and 4B are block diagrams illustrating exemplary processing devices according to some embodiments of the present disclosure;

FIG. 5 is a flowchart illustrating an exemplary process for determining a motion correction model according to some embodiments of the present disclosure;

FIG. 6 is a flowchart illustrating an exemplary process for an iteration step of training a motion correction model to some embodiments of the present disclosure;

FIG. 7 is a flowchart illustrating an exemplary process for evaluating a correction effect of a correction algorithm according to some embodiments of the present disclosure; and

FIG. 8 is a flowchart illustrating an exemplary process for determining a combined loss function according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is to describe particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the terms “system,” “unit,” “module,” and/or “block” used herein are one method to distinguish different components, elements, parts, sections, or assemblies of different levels in ascending order. However, the terms may be displaced by another expression if they achieve the same purpose.

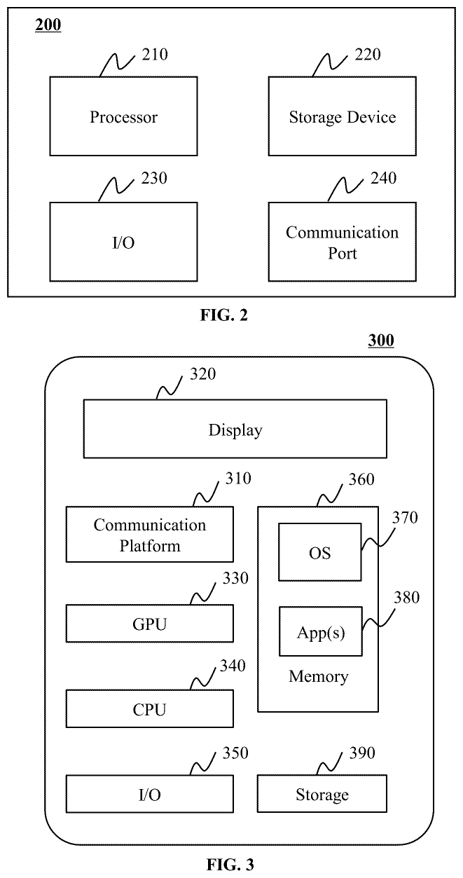

Generally, the words “module,” “unit,” or “block,” as used herein, refer to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processor 210 illustrated in FIG. 2 and/or the central processing unit (CPU) 340 illustrated FIG. 3) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may apply to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Provided herein are medical imaging systems and methods for non-invasive biomedical imaging/treatment, such as for disease diagnostic, disease therapy, or research purposes. In some embodiments, the medical imaging system may include a medical imaging system. The medical imaging system may include a single modality system and/or a multi-modality system. The term “modality” used herein broadly refers to an imaging or treatment method or technology that gathers, generates, processes, and/or analyzes imaging information of a subject or treatments the subject. The single modality system may include, for example, an ultrasound imaging system, an X-ray imaging system (e.g., a digital radiography (DR) system, a computed radiography (CR) system), a computed tomography (CT) system, a magnetic resonance imaging (MRI) system, an ultrasonography system, a single photon emission computed tomography (SPECT), a positron emission tomography (PET) system, an optical coherence tomography (OCT) imaging system, an ultrasound (US) imaging system, an intravascular ultrasound (IVUS) imaging system, a near-infrared spectroscopy (NIRS) imaging system, a digital subtraction angiography (DSA) system, or the like, or any combination thereof. The multi-modality system may include, for example, an X-ray imaging-magnetic resonance imaging (X-ray-MRI) system, a positron emission tomography-X-ray imaging (PET-X-ray) system, a single photon emission computed tomography-magnetic resonance imaging (SPECT-MRI) system, a positron emission tomography-computed tomography (PET-CT) system, a C-arm system, a positron emission tomography-magnetic resonance imaging (PET-MR) system, a digital subtraction angiography-magnetic resonance imaging (DSA-MRI) system, etc. In some embodiments, the medical imaging system may include a treatment system. The treatment system may include a treatment plan system (TPS), an image-guided radiotherapy (IGRT) system, etc. The image-guided radiotherapy (IGRT) may include a treatment device and a medical imaging device. The treatment device may include a linear accelerator, a cyclotron, a synchrotron, etc., configured to perform radiotherapy on a subject. The treatment device may include an accelerator of species of particles including, for example, photons, electrons, protons, or heavy ions. The medical imaging device may include an MRI scanner, a CT scanner, etc. It should be noted that the medical imaging system described below is merely provided for illustration purposes, and not intended to limit the scope of the present disclosure.

In the present disclosure, the subject may include a biological object and/or a non-biological object. The biological subject may be a human being, an animal, a plant, or a specific portion, organ, and/or tissue thereof. For example, the subject may include a head, a neck, a thorax, a heart, a stomach, a blood vessel, a soft tissue, a tumor, a nodule, or the like, or any combination thereof. In some embodiments, the subject may be a man-made composition of organic and/or inorganic matters that are with or without life. The terms “object” and “subject” are used interchangeably in the present disclosure.

In the present disclosure, the term “image” may refer to a two-dimensional (2D) image, a three-dimensional (3D) image, or a four-dimensional (4D) image. In some embodiments, the term “image” may refer to an image of a region (e.g., a region of interest (ROI)) of a subject. As described above, the image may be a CT image, a PET image, an MR image, a fluoroscopy image, an ultrasound image, an Electronic Portal Imaging Device (EPID) image, etc.

As used herein, a representation of an object (e.g., a patient, a subject, or a portion thereof) in an image may be referred to as an “object” for brevity. For instance, a representation of an organ or tissue (e.g., a heart, a liver, a lung) in an image may be referred to as an organ or tissue for brevity. Further, an image including a representation of an object may be referred to as an image of an object or an image including an object for brevity. Still further, an operation performed on a representation of an object in an image may be referred to as an operation performed on an object for brevity. For instance, a segmentation of a portion of an image including a representation of an organ or tissue from the image may be referred to as a segmentation of an organ or tissue for brevity.

During an imaging scan of the heart of a patient, the heart beats ceaselessly, and coronary arteries of the heart may undergo relatively intense motions. The intense motion may introduce motion artifacts in the images of the heart. The motion artifacts may need to be corrected to obtain a corrected image of the heart for improving the image quality. A conventional artifact correction approach using a machine learning model may need to segment (or extract) the coronary arteries from the image of the heart before motion correction. The segmented coronary arteries may be corrected using the machine learning model and the corrected coronary arteries may then be combined with the image of the heart to generate the corrected image of the heart. However, the accuracy of the corrected coronary arteries may be affected by the accuracy of the segmented coronary arteries. Besides, the corrected image of the heart may look unnatural and/or with a poor correction effect on artifacts due to the combination operation and/or the segmentation operation. Additionally, in some embodiments, the machine learning model of the conventional artifact correction approach may be trained according to a global loss function, thereby affecting the correction effect of the machine learning model. Moreover, a coronary artery may be with a relatively small cross-section and not fixed in shape, and a left coronary artery or branches thereof may be different from a right coronary artery or branches thereof, which may affect the correction effect of the machine learning model and make the correction for different coronary arteries unstable.

An aspect of the present disclosure relates to systems and methods for motion correction. The systems may obtain a plurality of training samples. Each of the plurality of training samples may include a sample image of a heart (e.g., the heart of a patient) and a gold standard image of the heart. The sample image may have a motion artifact and the gold standard image may be with substantial removal of the motion artifact. The systems may determine a motion correction model by training, based on the plurality of training samples according to a combined loss function, a preliminary model. The combined loss function may include at least a local loss function.

According to the systems and methods of the present disclosure, the motion correction model may be trained according to the combined loss function, which considers local and global loss functions during training. A corrected image may be generated using the motion correction model by inputting a medical image (e.g., an image of the heart of a patient) with motion artifact(s) to the motion correction model. That is, the corrected image may be determined without segmenting the medical image, and artifacts of the coronary arteries of the heart in the medical image can be corrected efficiently and accurately.

In some embodiments, the combined loss function may be used to evaluate a correction effect of a correction algorithm (e.g., a machine learning model for motion correction). For example, an initial image may be corrected using the correction algorithm to obtain a corrected image. A value of the combined loss function may be determined based on the corrected image and a gold standard image corresponding to the initial image. The combined loss function may include at least a local loss function associated with a first local region of the corrected image and a second local region of the gold standard image. Then, the correction effect of the correction algorithm may be evaluated based on the value of the combined loss function. Accordingly, the correction effect of the motion correction algorithm may be evaluated automatically and quantitatively by using the combined loss function.

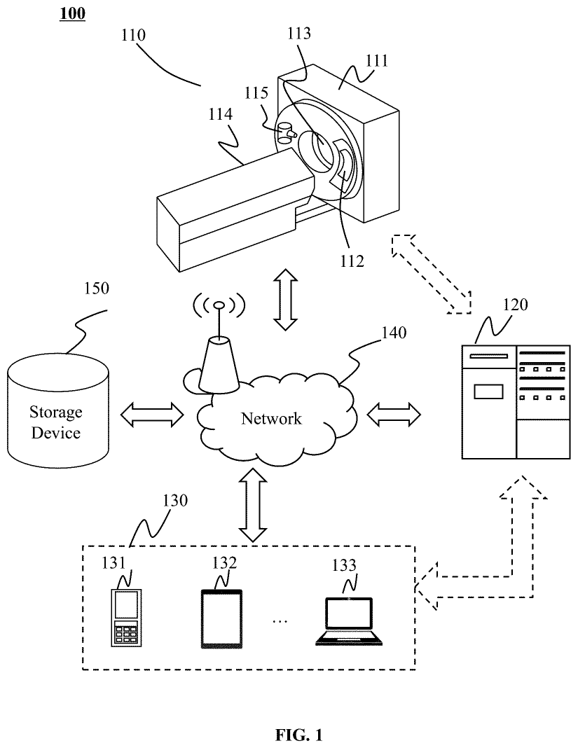

FIG. 1 is a schematic diagram illustrating an exemplary medical imaging system according to some embodiments of the present disclosure. As illustrated, the medical imaging system 100 may include a medical imaging device 110, a processing device 120, a terminal device 130, a network 140, and a storage device 150. The components of the medical imaging system 100 may be connected in one or more of various ways. Mere by way of example, as illustrated in FIG. 1, the medical imaging device 110 may be connected to the processing device 120 through the network 140. As another example, the medical imaging device 110 may be connected to the processing device 120 directly (as indicated by the bi-directional arrow in dotted lines linking the medical imaging device 110 and the processing device 120). As a further example, the storage device 150 may be connected to the processing device 120 directly or through the network 140. As still a further example, the terminal device 130 may be connected to the processing device 120 directly (as indicated by the bi-directional arrow in dotted lines linking the terminal device 130 and the processing device 120) or through the network 140.

The medical imaging device 110 may be configured to acquire image data relating to at least one part of a subject. The medical imaging device 110 may scan the subject or a portion thereof that is located within its detection region and generate image data (e.g., an initial image) relating to the subject or the portion thereof. The image data relating to at least one part of a subject may include an image (e.g., an image slice), projection data, or a combination thereof. In some embodiments, the medical imaging device 110 may include a single modality imaging device. For example, the medical imaging device 110 may include a CT device, an MRI device, a DSA device, a PET device, a SPECT device, an ultrasonography scanner, an X-ray imaging device (e.g., a DR scanner, a computed radiography (CR) scanner), or the like, or any combination thereof. In some embodiments, the medical imaging device 110 may include a multi-modality imaging device. Exemplary multi-modality imaging devices may include a PET-CT device, a PET-MRI device, or the like, or a combination thereof. The following descriptions are provided, unless otherwise stated expressly, with reference to a CT device for illustration purposes and not intended to be limiting.

As illustrated, the medical imaging device 110 may include a gantry 111, a detector 112, a detecting region 113, a table 114, and a radiation source 115. The gantry 111 may support the detector 112 and the radiation source 115. The gantry 111 may rotate, for example, clockwise or counterclockwise about an axis of rotation of the gantry 111. The radiation source 115 may rotate together with the gantry 111. The subject may be placed on the table 114 and moved to the detecting region 113 along with a movement of the table 114. The radiation source 115 may emit a beam of radiation rays to the subject. The detector 112 may detect the radiation beam (e.g., X-rays) passing through the detecting region 113. After the detector 112 receives the radiation beam passing through the subject, the received radiation beam may be converted into visible lights. The visible lights may be converted into electrical signals. The electrical signals may be further converted into digital information using an analog-to-digital (AD) converter. The digital information may be transmitted to a computing device (e.g., the processing device 120) for processing, or transmitted to a storage device (e.g., the storage device 150) for storage. In some embodiments, the detector 112 may include one or more detector units. The detector unit(s) may be and/or include single-row detector elements and/or multi-row detector elements.

The processing device 120 may process data and/or information obtained from the medical imaging device 110, the terminal device 130, and/or the storage device 150. For example, the processing device 120 may correct an initial image using a correction algorithm to obtain a corrected image. The processing device 120 may obtain a gold standard image corresponding to the initial image. The processing device 120 may evaluate a correction effect of the correction algorithm based on a combined loss function associated with the corrected image and the gold standard image. As another example, the processing device 120 may obtain a plurality of training samples each of which includes a sample image of a heart and a gold standard image of the heart. The sample image may have a motion artifact and the gold standard image may be with substantial removal of the motion artifact. The processing device 120 may determine a motion correction model by training, based on the plurality of training samples according to a combined loss function, a preliminary model. The combined loss function may include at least a local loss function.

In some embodiments, the generation (e.g., training) and/or updating of the motion correction model may be performed on a processing device, while the application of the motion correction model may be performed on a different processing device. In some embodiments, the generation and/or updating of the motion correction model may be performed on a processing device of a system different from the medical imaging system 100 or a server different from a server including the processing device 120 on which the application of the motion correction model is performed. For instance, the generation and/or updating of the motion correction model may be performed on a first system of a vendor who provides and/or maintains such a motion correction model and/or has access to training samples used to generate the motion correction model, while motion correction based on the provided motion correction model may be performed on a second system of a client of the vendor. In some embodiments, the generation and/or updating of the motion correction model may be performed on a first processing device of the medical imaging system 100, while the application of the motion correction model may be performed on a second processing device of the medical imaging system 100. In some embodiments, the generation and/or updating of the motion correction model may be performed online in response to a request for motion correction. In some embodiments, the generation and/or updating of the motion correction model may be performed offline.

In some embodiments, the motion correction model may be generated (e.g., trained) and/or updated (or maintained) by, e.g., the manufacturer of the medical imaging device 110 or a vendor. For instance, the manufacturer or the vendor may load the motion correction model into the medical imaging system 100 or a portion thereof (e.g., the processing device 120) before or during the installation of the medical imaging device 110 and/or the processing device 120, and maintain or update the motion correction model from time to time (periodically or not). The maintenance or update may be achieved by installing a program stored on a storage device (e.g., a compact disc, a USB drive, etc.) or retrieved from an external source (e.g., a server maintained by the manufacturer or vendor) via the network 150. The program may include a new model (e.g., a new motion correction model) or a portion thereof that substitutes or supplements a corresponding portion of the motion correction model.

In some embodiments, the processing device 120 may include a central processing unit (CPU), a digital signal processor (DSP), a system on a chip (SoC), a microcontroller unit (MCU), or the like, or any combination thereof. In some embodiments, the processing device 120 may include a computer, a user console, a single server or a server group, etc. The server group may be centralized or distributed. In some embodiments, the processing device 120 may be local or remote. For example, the processing device 120 may access information and/or data stored in the medical imaging device 110, the terminal device 130, and/or the storage device 150 via the network 140. As another example, the processing device 120 may be directly connected to the medical imaging device 110, the terminal device 130, and/or the storage device 150 to access stored information and/or data. In some embodiments, the processing device 120 may be implemented on a cloud platform (e.g., a private cloud, a public cloud, a hybrid cloud, a community cloud, a distributed cloud, an inter-cloud, a multi-cloud, or the like, or any combination thereof). In some embodiments, the processing device 120 or a portion of the processing device 120 may be integrated into the medical imaging device 110. In some embodiments, the processing device 120 may be implemented by a computing device 200 including one or more components as described in FIG. 2.

The terminal device 130 may input/output signals, data, information, etc. In some embodiments, the terminal device 130 may enable user interaction with the processing device 120. For example, the terminal device 130 may display a corrected image of a subject on a screen. As another example, the terminal device 130 may obtain a user's input information through an input device (e.g., a keyboard, a touch screen, a brain wave monitoring device), and transmit the input information to the processing device 120 for further processing. The terminal device 130 may include a mobile device 131, a tablet computer 132, a laptop computer 133, or the like, or any combination thereof. In some embodiments, the mobile device 131 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, a footgear, eyeglasses, a helmet, a watch, clothing, a backpack, a smart accessory, or the like, or any combination thereof. In some embodiments, the smart mobile device may include a mobile phone, a personal digital assistant (PDA), a gaming device, a navigation device, a point of sale (POS) device, a desktop, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include a Google Glass™, an Oculus Rift™, a Hololens™, a Gear VR™, etc. In some embodiments, the terminal device 130 may be part of the processing device 120.

The network 140 may include any suitable network that can facilitate the exchange of information and/or data for the medical imaging system 100. In some embodiments, one or more components (e.g., the medical imaging device 110, the processing device 120, the storage device 150, the terminal device 130) of the medical imaging system 100 may communicate information and/or data with one or more other components of the medical imaging system 100 via the network 140. For example, the processing device 120 may obtain data from the medical imaging device 110 via the network 140. As another example, the terminal device 130 may receive a reconstructed image from the processing device 120 via the network 140. In some embodiments, one or more components (e.g., the medical imaging device 110, the processing device 120, the storage device 150, the terminal device 130) of the medical imaging system 100 may communicate information and/or data with one or more external resources such as an external database of a third party, etc. For example, the processing device 120 may obtain an optimizing model from a database of a vendor or manufacture (e.g., a manufacture of the medical imaging device 110) that provides and/or updates the optimizing model. The network 140 may be and/or include a public network (e.g., the Internet), a private network (e.g., a local area network (LAN), a wide area network (WAN)), etc.), a wired network (e.g., an Ethernet network), a wireless network (e.g., an 802.11 network, a Wi-Fi network, etc.), a cellular network (e.g., a Long Term Evolution (LTE) network), a frame relay network, a virtual private network (“VPN”), a satellite network, a telephone network, routers, hubs, switches, server computers, and/or any combination thereof. Merely by way of example, the network 140 may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network 140 may include one or more network access points. For example, the network 140 may include wired and/or wireless network access points, such as base stations and/or internet exchange points, through which one or more components of the medical imaging system 100 may be connected to the network 140 to exchange data and/or information.

The storage device 150 may store data, instructions, and/or any other information. In some embodiments, the storage device 150 may store data obtained from the medical imaging device 110, the terminal device 130, and/or the processing device 120. In some embodiments, the storage device 150 may store data and/or instructions that the processing device 120 may execute or use to perform exemplary methods described in the present disclosure. In some embodiments, the storage device 150 may include a mass storage device, a removable storage device, a volatile read-and-write memory, a read-only memory (ROM), or the like, or a combination thereof. Exemplary mass storage devices may include a magnetic disk, an optical disk, a solid-state drive, etc. Exemplary removable storage devices may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), a digital versatile disk ROM, etc. In some embodiments, the storage device 150 may be implemented on a cloud platform as described elsewhere in the disclosure.

In some embodiments, the storage device 150 may be connected to the network 140 to communicate with one or more components (e.g., the medical imaging device 110, the processing device 120, the terminal device 130) of the medical imaging system 100. One or more components of the medical imaging system 100 may access the data or instructions stored in the storage device 150 via the network 140. In some embodiments, the storage device 150 may be directly connected to or communicate with one or more components of the medical imaging system 100. In some embodiments, the storage device 150 may be part of the processing device 120 or the terminal device 130.

It should be noted that the above description of the medical imaging system 100 is merely provided for the purposes of illustration, and not intended to limit the scope of the present disclosure. For persons having ordinary skills in the art, multiple variations and modifications may be made under the teachings of the present disclosure. For example, the medical imaging system 100 may include one or more additional components, and/or one or more components of the medical imaging system 100 described above may be omitted. Additionally or alternatively, two or more components of the medical imaging system 100 may be integrated into a single component. A component of the medical imaging system 100 may be implemented on two or more sub-components.

FIG. 2 is a schematic diagram illustrating exemplary hardware and/or software components of an exemplary computing device according to some embodiments of the present disclosure. The computing device 200 may be used to implement any component of the medical imaging system 100 as described herein. For example, the processing device 120 and/or the terminal device 130 may be implemented on the computing device 200, respectively, via its hardware, software program, firmware, or a combination thereof. Although only one such computing device is shown, for convenience, the computer functions relating to the medical imaging system 100 as described herein may be implemented in a distributed fashion on a number of similar platforms, to distribute the processing load. As illustrated in FIG. 2, the computing device 200 may include a processor 210, a storage device 220, an input/output (I/O) 230, and a communication port 240.

The processor 210 may execute computer instructions (e.g., program codes) and perform functions of the processing device 120 in accordance with techniques described herein. The computer instructions may include, for example, routines, programs, objects, components, data structures, procedures, modules, and functions, which perform particular functions described herein. For example, the processor 210 may process scanning data obtained from the medical imaging device 110, the storage device 150, the terminal device 130, and/or any other components of the medical imaging system 100. As another example, the processor 210 may generate a reconstructed image based on the scanning data.

In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or a combination thereof.

Merely for illustration, only one processor is described in the computing device 200. However, it should be noted that the computing device 200 in the present disclosure may also include multiple processors. Thus operations and/or method steps that are performed by one processor as described in the present disclosure may also be jointly or separately performed by the multiple processors. For example, if in the present disclosure the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage device 220 may store data/information obtained from the medical imaging device 110, the storage device 150, the terminal device 130, and/or any other component of the medical imaging system 100. In some embodiments, the storage device 220 may include a mass storage device, a removable storage device, a volatile read-and-write memory, a read-only memory (ROM), or the like, or a combination thereof. In some embodiments, the storage device 220 may store one or more programs and/or instructions to perform exemplary methods described in the present disclosure. For example, the storage device 220 may store a program for the processing device 120 to execute to determine an optimizing model. As another example, the storage device 220 may store a program for the processing device 120 to execute to apply the optimizing model to determine an optimized image.

The I/O 230 may input and/or output signals, data, information, etc. In some embodiments, the I/O 230 may enable user interaction with the processing device 120. In some embodiments, the I/O 230 may include an input device and an output device. The input device may include alphanumeric and other keys that may be input via a keyboard, a touch screen (for example, with haptics or tactile feedback), a speech input, an eye tracking input, a brain monitoring system, or any other comparable input mechanism. The input information received through the input device may be transmitted to another component (e.g., the processing device 120) via, for example, a bus, for further processing. Other types of the input device may include a cursor control device, such as a mouse, a trackball, or cursor direction keys, etc. The output device may include a display (e.g., a liquid crystal display (LCD), a light-emitting diode (LED)-based display, a flat panel display, a curved screen, a television device, a cathode ray tube (CRT), a touch screen), a speaker, a printer, or the like, or a combination thereof.

The communication port 240 may be connected to a network (e.g., the network 140) to facilitate data communications. The communication port 240 may establish connections between the processing device 120 and one or more components (e.g., the medical imaging device 110, the storage device 150, and/or the terminal device 130) of the medical imaging system 100. The connection may be a wired connection, a wireless connection, any other communication connection that can enable data transmission and/or reception, and/or a combination of these connections. The wired connection may include, for example, an electrical cable, an optical cable, a telephone wire, or the like, or a combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 240 may be and/or include a standardized communication port, such as RS232, RS485, etc. In some embodiments, the communication port 240 may be a specially designed communication port. For example, the communication port 240 may be designed in accordance with the digital imaging and communications in medicine (DICOM) protocol.

FIG. 3 is a schematic diagram illustrating exemplary hardware and/or software components of an exemplary mobile device according to some embodiments of the present disclosure. In some embodiments, one or more components (e.g., the terminal device 130, the processing device 120) of the medical imaging system 100 may be implemented on one or more components of the mobile device 300.

As illustrated in FIG. 3, the mobile device 300 may include a communication platform 310, a display 320, a graphics processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to the medical imaging system 100. User interactions with the information stream may be achieved via the I/O 350 and provided to the processing device 120 and/or other components of the medical imaging system 100 via the network 140.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to generate an image as described herein. A computer with user interface elements may be used to implement a personal computer (PC) or another type of work station or terminal device, although a computer may also act as a server if appropriately programmed. It is believed that those skilled in the art are familiar with the structure, programming and general operation of such computer equipment and as a result, the drawings should be self-explanatory.

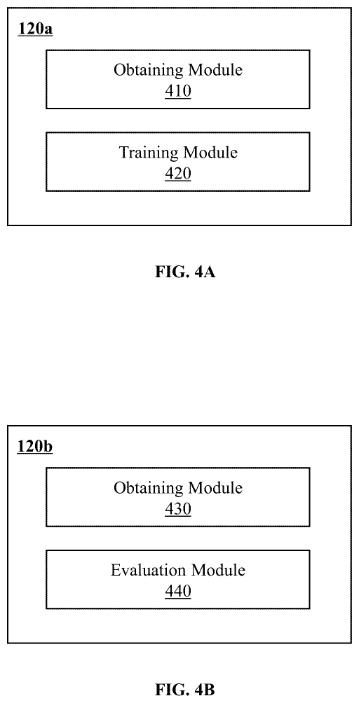

FIGS. 4A and 4B are block diagrams illustrating exemplary processing devices according to some embodiments of the present disclosure. In some embodiments, the processing devices 120a and 120b may be embodiments of the processing device 120 as described in connection with FIG. 1. In some embodiments, the processing devices 120a and 120b may be respectively implemented on a processing unit (e.g., the processor 210 illustrated in FIG. 2 or the CPU 340 as illustrated in FIG. 3). Merely by way of example, the processing device 120a may be implemented on a CPU 340 of a terminal device, and the processing device 120b may be implemented on a computing device 200. Alternatively, the processing devices 120a and 120b may be implemented on a same computing device 200, or a same CPU 340. For example, the processing devices 120a and 120b may be implemented on a same computing device 200 which includes an obtaining module, a training module, and an evaluation module.

The processing device 120a may include an obtaining module 410 and a training module 420.

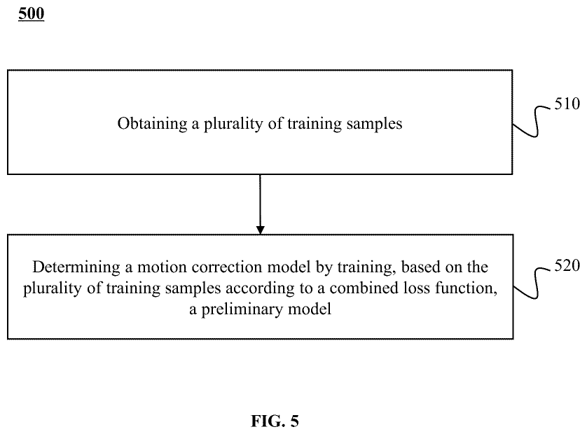

The obtaining module 410 may be configured to obtain data/information relating to model training. For example, the obtaining module 40 may obtain a plurality of training samples from one or more components (e.g., the storage device 150, the storage device 220, the storage 390, or the terminal device 130) of the medical imaging system 100 or an external storage device of the medical imaging system 100. Each of the plurality of training samples may include a sample image of a heart and a gold standard image of the heart. The sample image may have a motion artifact (e.g., in coronary arteries of the heart). The gold standard image may be with substantial removal of the motion artifact. More descriptions regarding the obtaining of the plurality of training samples may be found elsewhere in the present disclosure (e.g., operation 510 in FIG. 5 and the description thereof). As another example, the obtaining module 410 may obtain a preliminary model from one or more components (e.g., the storage device 150, the storage device 220, or the storage 390) of the medical imaging system 100 or an external storage device of the medical imaging system 100, more descriptions of which may be found elsewhere in the present disclosure (e.g., operation 520 in FIG. 5 and the description thereof). As still another example, the obtaining module 410 may obtain (e.g., by retrieving) a combined loss function from one or more components of the present disclosure. The combined loss function may include one or more loss functions each of which corresponds to a specific weight. Alternatively, the obtaining module 410 may determine the combined loss function (e.g., adjusting weights of loss functions of the combined loss function) based on a plurality of corrected images of an initial image and a gold standard image corresponding to the initial image. More descriptions regarding the obtaining of the combined loss function may be found elsewhere in the present disclosure (e.g., FIG. 8 and the description thereof).

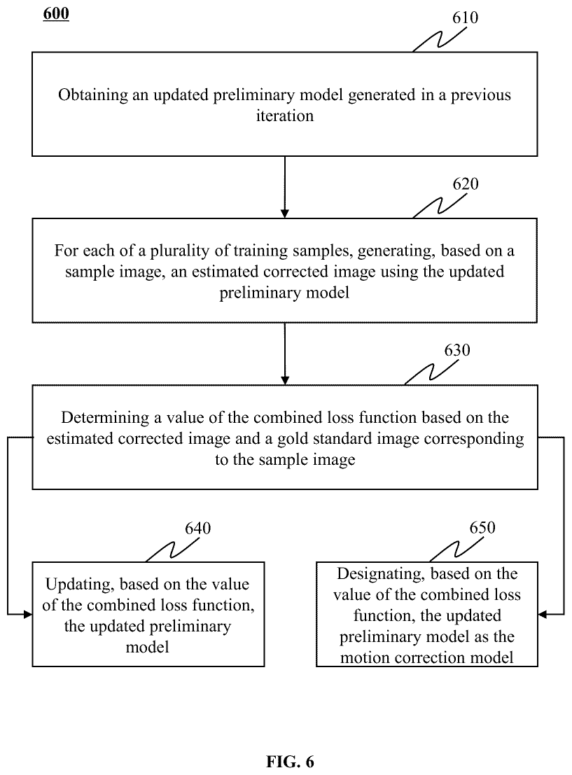

The training module 420 may be configured to determine a motion correction model. For example, the training module 420 may determine the motion correction model by training, based on the plurality of training samples according to a combined loss function, a preliminary model. The combined loss function may include a combination of one or more loss functions (e.g. a combination of two or more loss functions). For instance, the combined loss function may include at least a local loss function (e.g., one or more local loss functions). In some embodiments, the training module 420 may train the preliminary model according to an iterative operation including one or more iterations. For example, the training module 420 may obtain an updated preliminary model generated in a previous iteration. For the each of the plurality of training samples, the training module 420 may generate, based on the sample image, an estimated corrected image using the updated preliminary model. The training module 420 may determine a value of the combined loss function based on the estimated corrected image and the gold standard image (e.g., by determining a mask of a coronary artery of the heart). The training module 420 may update the updated preliminary model based on the value of the combined loss function, or designate the updated preliminary model as the motion correction model based on the value of the combined loss function. More descriptions regarding the training of the motion correction model may be found elsewhere in the present disclosure (e.g., operation 520 in FIG. 5, FIG. 6, and the descriptions thereof).

The processing device 120b may include an obtaining module 430 and an evaluation module 440.

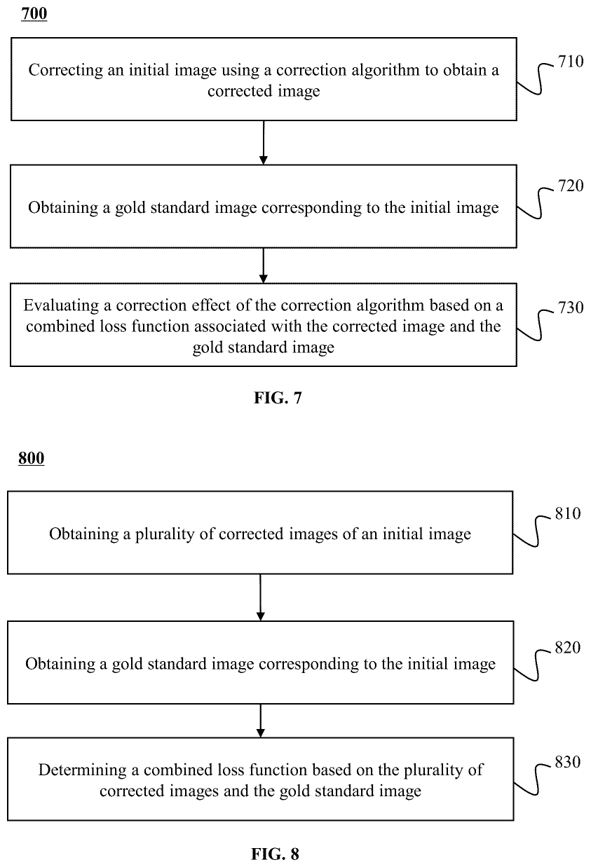

The obtaining module 430 may be configured to obtain information/data relating to correction effect evaluation. For example, the obtaining module 430 may obtain an initial image with a motion artifact. As another example, the obtaining module 430 may obtain a corrected image of the initial image, e.g., by correcting the initial image using a correction algorithm. As still another example, the obtaining module 430 may obtain a gold standard image corresponding to the initial image. More descriptions regarding the obtaining of the initial image and/or the gold standard image thereof may be found elsewhere in the present disclosure (e.g., operations 710 and/or 720 in FIG. 7 and the descriptions thereof).

The evaluation module 440 may be configured to evaluate a correction effect of a correction algorithm. For example, the evaluation module 440 may determine a value of a combined loss function based on the corrected image determined using the correction algorithm and the initial image. The evaluation module 440 may evaluate the correction effect based on the value of the combined loss function. The combined loss function may include at least a local loss function associated with a first local region of the corrected image and a second local region of the gold standard image. The first local region and the second local region may include a coronary artery. The higher the value of the combined loss function is, the better the correction effect of the correction algorithm may be. More descriptions regarding the evaluation of the correction effect may be found elsewhere in the present disclosure (e.g., operation 730 in FIG. 7 and the description thereof).

The modules in the processing device 120 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth™, a ZigBee™, a Near Field Communication (NFC), or the like, or any combination thereof. In some embodiments, the processing device 120 may include one or more additional modules. For example, the processing device 120 may also include a transmission module (not shown) configured to transmit data and/or information (e.g., the corrected image, or the motion correction model) to one or more components (e.g., the medical imaging device 110, the terminal device 130, the storage device 150) of the medical imaging system 100. As another example, the processing device 120 may include a storage module (not shown) used to store information and/or data (e.g., the corrected image, or the motion correction model) associated with motion correction. In some embodiments, two or more of the modules may be combined into a single module, and any one of the modules may be divided into two or more units. For example, the obtaining module 410 and the obtaining module 430 may be combined as a single module or be the same module that has functions of both the obtaining module 410 and the obtaining module 430. As another example, the obtaining module 410 may be divided into two units including a first unit for obtaining the plurality of training samples, and a second unit for obtaining (or determining) the combined loss function and the preliminary model.

FIG. 5 is a flowchart illustrating an exemplary process for determining a motion correction model according to some embodiments of the present disclosure. In some embodiments, process 500 may be executed by the medical imaging system 100. For example, the process 500 may be implemented as a set of instructions (e.g., an application) stored in a storage device (e.g., the storage device 150, the storage device 220, and/or the storage 390). In some embodiments, the processing device 120a (e.g., the processor 210 of the computing device 200, the CPU 340 of the mobile device 300, and/or one or more modules illustrated in FIG. 4A) may execute the set of instructions and may accordingly be directed to perform the process 500. The operations of the illustrated process presented below are intended to be illustrative. In some embodiments, the process 500 may be accomplished with one or more additional operations not described and/or without one or more of the operations discussed. Additionally, the order of the operations of process 500 illustrated in FIG. 5 and described below is not intended to be limiting.

In 510, the processing device 120a (e.g., the obtaining module 410) may obtain a plurality of training samples.

In some embodiments, each of the plurality of training samples may include a sample image of a sample subject and a gold standard image of the sample subject. The sample image may include a 2D image, a 3D image, etc. The sample image may have a motion artifact. The gold standard image may be with substantial removal of the motion artifact. For example, the gold standard image may have no motion artifact. As another example, a motion artifact in the gold standard image may be less than a preset level of artifact. As used herein, a sample subject refers to an object whose data is used for training the motion correction model. The sample subjects corresponding to the plurality of training samples may meet one or more preset conditions and include subjects of different genders and/or different ages. The sample subject(s) or a portion thereof may undergo a motion during the acquisition of the sample image(s). For example, the sample subject may include the heart of a sample patient (e.g., a left and/or right ventricle of the heart), a blood vessel of the sample patient (e.g., a left and/or right coronary artery), a lung of the sample patient, etc. For illustration purposes, the sample subjects may be described with reference to heart(s). That is, each of the plurality of training samples may include a sample image of the heart and a gold standard image of the heart.

In some embodiments, the plurality of training samples may be pre-generated and stored in one or more components (e.g., the storage device 150, the storage device 220, the storage 390, or the terminal device 130) of the medical imaging system 100 or an external storage device that the medical imaging system 100 can access. The processing device 120a may obtain the plurality of the training samples from the one or more components of the medical imaging system 100 or the external storage device via the network 140. In some embodiments, the processing device 120a may obtain a portion of the training samples and generate the remaining training samples based on the portion of the training samples. For example, for the each of the plurality of training samples, the processing device 120a may generate the gold standard image of the heart based on the sample image of the heart (e.g., using a traditional motion correction algorithm and/or an existing correction model). As another example, the processing device 120a may obtain one or more sample images of the heart based on a gold standard image of the heart (i.e., at least a portion of the plurality of training samples (e.g., one or more sample images) may correspond to a same gold standard image). Specifically, the processing device 120a may obtain a gold standard image, and determine one or more sample images through simulation (e.g., by adding different levels of artifacts into the gold standard image). In some embodiments, for each training sample, the gold standard image may correspond to the sample image, and the gold standard image and the sample image of the each training sample may derive from a same image (e.g., the gold standard image may be obtained from the sample image, or the sample image may be obtained from the gold standard image).

In 520, the processing device 120a (e.g., the training module 420) may determine a motion correction model by training, based on the plurality of training samples according to a combined loss function, a preliminary model.

As used herein, the combined loss function refers to a combination of one or more loss functions each of which may be associated with a local region or a global region of the heart (or the sample image(s)). For example, the combined loss function may include one or more local loss functions, a dice related loss function, a global loss function, or the like, or any combination thereof. As used herein, a local loss function refers to a loss function associated with a third local region of the heart (or the sample image(s)). In some embodiments, the local loss function may relate to a mask region. The mask region may be associated with the third local region with relatively obvious artifact(s) and/or relatively large level of artifacts in an image. Exemplary third local regions may include a coronary artery (or a portion thereof) of the heart, a myocardium (or a portion thereof) of the heart, a stent region (or a portion thereof) of the heart, etc. The processing device 120a may determine the mask region by determining a mask corresponding to the third local region of the heart. As used herein, a dice related loss function refers to a loss function associated with a fourth local region of the heart (or the sample image(s)). In some embodiments, the processing device 120a may determine the fourth local region using a segmentation algorithm (e.g., a coronary artery extraction algorithm). The third local region and the fourth local region may be the same or different. In some embodiments, the third local region may include the fourth local region. As used herein, a global loss function refers to a loss function associated with a global region of the heart (or the sample image(s)). The processing device 120a may determine the global region without segmentation in comparison with the determination of the local region.

In some embodiments, the combined loss function may be pre-stored in the one or more components (e.g., the storage device 150, the storage device 220, or the storage 390) of the medical imaging system 100 or an external storage device of the medical imaging system 100. The processing device 120a may obtain (e.g., by retrieving) the combined loss function from the one or more components of the medical imaging system 100 or the external storage device of the medical imaging system 100. Alternatively, the processing device 120a may determine the combined loss function (e.g., determining and/or adjusting weights of the one or more loss functions of the combined loss function) based on a plurality of corrected images of an initial image and a gold standard image corresponding to the initial image. More descriptions regarding the obtaining of the combined loss function may be found elsewhere in the present disclosure (e.g., FIG. 8 and the description thereof).

In some embodiments, the preliminary model may include a machine learning model (e.g., a deep learning model, a neural network model). Merely by way of example, the preliminary model may include a deep belief network (DBN), a Stacked Auto-Encoders (SAE), a logistic regression (LR) model, a support vector machine (SVM) model, a decision tree model, a Naive Bayesian Model, a random forest model, or a Restricted Boltzmann Machine (RBM), a Gradient Boosting Decision Tree (GBDT) model, a LambdaMART model, an adaptive boosting model, a recurrent neural network (RNN) model, a convolutional neural network (CNN) model, a capsule neural network model, a transformer model, a hidden Markov model, a perceptron neural network model, a Hopfield network model, or the like, or any combination thereof. As used herein, the motion correction model refers to an algorithm or process configured to correct motion artifact(s) of a medical image. The motion correction model may include a trained machine learning model (e.g., a trained deep learning mode, a trained neural network model).

In some embodiments, the processing device 120a may train the preliminary model to generate the motion correction model according to a machine learning algorithm. The machine learning algorithm may include but not be limited to an artificial neural network algorithm, a deep learning algorithm, a decision tree algorithm, an association rule algorithm, an inductive logic programming algorithm, a support vector machine algorithm, a clustering algorithm, a Bayesian network algorithm, a reinforcement learning algorithm, a representation learning algorithm, a similarity and metric learning algorithm, a sparse dictionary learning algorithm, a genetic algorithm, a rule-based machine learning algorithm, or the like, or any combination thereof. The machine learning algorithm used to generate the motion correction model may be a supervised learning algorithm, a semi-supervised learning algorithm, an unsupervised learning algorithm, or the like.

In some embodiments, the processing device 120a may determine the motion correction model by training the preliminary model according to an iterative operation including one or more iterations. Taking a current iteration of the one or more iterations as an example, the processing device 120a may obtain an updated preliminary model generated in a previous iteration. For the each of the plurality of training samples, the processing device 120a may generate, based on the sample image, an estimated corrected image using the updated preliminary model. The processing device 120a may determine a value of the combined loss function based on the estimated corrected image and the gold standard image. Further, the processing device 120a may update the updated preliminary model based on the value of the combined loss function, or designate the updated preliminary model as the motion correction model based on the value of the combined loss function. Alternatively, the processing device 120a may designate the updated preliminary model as the motion correction model when a termination condition is satisfied. More descriptions regarding the generation of the motion correction model may be found elsewhere in the present disclosure (e.g., FIG. 6 and relevant descriptions thereof.

In some embodiments, during the training of the motion correction model, the segmentation operation may be performed on the training sample(s) for determining the combined loss function. Whereas during the application of the motion correction model, there is no need to determine the combined loss function, accordingly, there is no need to perform the segmentation operation. In addition, during the application of the motion correction model, an input of the motion correction model may include a medical image (e.g., an image of the heart of a patient) with motion artifact(s), and an output of the motion correction model may include a corrected image of the medical image. Thus, the medical image may be corrected using the motion correction model without performing a segmentation operation on the medical image and/or a combination operation on the corrected medical image and the medical image, thereby improving the efficiency and accuracy of motion correction.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the process 500 may be accomplished with one or more additional operations not described and/or without one or more of the operations discussed above. For example, the process 500 may include an additional transmitting operation in which the processing device 120a may transmit the motion correction model to the storage device 150 for storage. As another example, the process 500 may include a test operation in which the processing device 120a may test the motion correction model using a set of testing samples. The set of testing samples may be similar to the training sample(s). For instance, a testing sample may include a sample image and a gold standard image corresponding to the sample image. The sample image may be input to the motion correction model, and the motion correction model may output a testing corrected image of the sample image. The processing device 120a may test the motion correction model based on a difference between the testing corrected image and the gold standard image (e.g., based on a combined loss function associated with the testing corrected image and the gold standard image). Additionally or alternatively, the processing device 120a may update the motion correction model periodically or aperiodically based on one or more newly-generated training samples.

FIG. 6 is a flowchart illustrating an exemplary process for an iteration step of training a motion correction model according to some embodiments of the present disclosure. In some embodiments, process 600 may be executed by the medical imaging system 100. For example, the process 600 may be implemented as a set of instructions (e.g., an application) stored in a storage device (e.g., the storage device 150, the storage device 220, and/or the storage 390). In some embodiments, the processing device 120a (e.g., the processor 210 of the computing device 200, the CPU 340 of the mobile device 300, and/or one or more modules illustrated in FIG. 4A) may execute the set of instructions and may accordingly be directed to perform the process 600. The operations of the illustrated process presented below are intended to be illustrative. In some embodiments, the process 600 may be accomplished with one or more additional operations not described and/or without one or more of the operations discussed. Additionally, the order of the operations of process 600 illustrated in FIG. 6 and described below is not intended to be limiting. In some embodiments, one or more operations of process 600 may be performed to achieve at least part of operation 520 as described in connection with FIG. 5. For example, the process 600 may be performed to achieve a current iteration in training the motion correction model. In some embodiments, a same set or different sets of training samples may be used in different iterations in training the motion correction model.

In 610, the processing device 120a (e.g., the training module 420) may obtain an updated preliminary model generated in a previous iteration.

In some embodiments, for the current iteration being a first iteration, the processing device 120a may obtain the preliminary model as described in operation 520. For the current iteration being a subsequent iteration of the first iteration, the processing device 120 may obtain the updated preliminary model generated in the previous iteration.

In 620, for each of a plurality of training samples, the processing device 120a (e.g., the training module 420) may generate, based on a sample image, an estimated corrected image using the updated preliminary model.

In some embodiments, the processing device 120a may input the sample image into the updated preliminary model, and the updated preliminary model may output the estimated corrected image by processing the sample image (without the need for determining (e.g., segmenting or extracting) a coronary artery from the sample image).

In 630, the processing device 120 (e.g., the training module 420) may determine a value of a combined loss function based on the estimated corrected image and a gold standard image corresponding to the sample image.

As described in connection with operation 520, the combined loss function may include one or more loss functions. In some embodiments, the combined loss function may include a combination of two or more loss functions. In some embodiments, the processing device 120a may determine the value of the combined loss function by a weighted sum of values of the one or more loss functions. In some embodiments, each of the loss functions may correspond to a specific weight. In some embodiments, different loss functions may correspond to different weights. For example, the combined loss function may include a local loss function (e.g., associated with the coronary artery), a dice related loss function associated with the coronary artery, and a global loss function, as expressed in Equation (1):

$${Loss}_{com} = {α}_{0} {Loss}_{global} + {α}_{1} {Loss}_{local} + {α}_{2} {Loss}_{dice} , \qquad ( 1 )$$

where Loss_{com} denotes the combined loss function, Loss_{local} denotes the value of the local loss function, Loss_{dice} denotes the dice related loss function, Loss_{global} denotes the global loss function, α₁ denotes a weight (also referred to as a first weight) of the local loss function, α₂ denotes a weight (also referred to as a second weight) of the dice related loss function, and α₀ denotes a weight (also referred to as a third weight) of the global loss function. In some embodiments, a first significance of the local loss function may be higher than the second significance of the dice related loss function. For example, the value of the local loss function multiplied by the first weight (i.e., α₀Loss_{global}) may be larger than the value of dice related loss function multiplied by the second weight (i.e., α₂Loss_{dice}). In some embodiments, the second significance of the dice related loss function may be higher than a third significance of the global loss function. For example, the value of the dice related loss function multiplied by the second weight (i.e., α₂Loss_{dice}) may be larger than the value of the global loss function multiplied by third weight (i.e., α₀Loss_{global}).

In some embodiments, the combined loss function may include two local loss functions (e.g., one being associated with the coronary artery, and another one being associated with the myocardium), a dice related loss function associated with the coronary artery, and/or a global loss function. In some embodiments, a fourth significance of the local loss function associated with the myocardium may be lower than the first significance, since an artifact in the myocardium is generally less than an artifact in the coronary artery. In some embodiments, the weights (e.g., the first weight, the second weight, the third weight, and/or the fourth weight) of the one or more loss functions may be determined (or adjusted) as described in FIG. 8 and the description thereof.

In some embodiments, the processing device 120a may determine a value of a local loss function associated with a local region by determining a mask corresponding to the local region. Taking the local region associated with a coronary artery as an example, the processing device 120a may extract a centerline of the coronary artery from the gold standard image (e.g., using a centerline extraction algorithm or model). The centerline extraction algorithm or model may be based on morphological operators, model-fitting, medialness filter, fuzzy connectedness, connected component analysis and wave propagation, an improved Frangi's vesselness filter, a CNN-based orientation classifier, or the like, or any combination thereof. The processing device 120a may determine a mask by performing an expansion operation on the centerline. As used herein, a mask refers to a binary image including information (e.g., a size, a shape, a motion range, etc.) of the coronary artery. For example, the processing device 120a may perform the expansion operation on the centerline according to a preset radius of the coronary artery. In some embodiments, the region obtained after expansion operation may be larger than the coronary artery, such that the mask includes information of the entire coronary artery. The preset radius may be a default setting of the medical imaging system 100 or adjustable according to the experience of a user (e.g., a doctor, an operator, or a technician). In some embodiments, the processing device 120a may extract the coronary artery from the gold standard image (e.g., using a coronary artery extraction algorithm or model such as a threshold segmentation algorithm or a topology extraction algorithm). The processing device 120a may determine the mask based on the extracted coronary artery. Further, the processing device 120a may determine the value of the local loss function based on the mask, the estimated corrected image, and the gold standard image.

In some embodiments, the processing device 120a may determine, in the estimated corrected image, a first local region (also referred to as a first mask region) corresponding to the coronary artery based on the mask and the estimated corrected image. The processing device 120a may determine, in the gold standard image, a second local region (also referred to as a second mask region) corresponding to the coronary artery based on the mask and the gold standard image. As used herein, the first local region may include one or more first sub-regions each of which corresponds to a part of the coronary artery. For example, the coronary artery may include a left coronary artery and a right coronary artery. The first local region may include two first sub-regions corresponding to the left coronary artery and the right coronary artery respectively. As another example, the coronary artery may include one or more branches. The first local may include one or more first sub-regions corresponding to the one or more es respectively. Similarly, the second local region may include one or more second sub-regions. Each of the one or more second sub-regions may correspond to one of the one or more second sub-regions. The processing device 120a may determine the value of the local loss function based on a difference between the first local region and the second local region. The difference between the first local region and the second local region may be determined based on the one or more first sub-regions and the one or more second sub-regions. For example, the processing device 120a may determine a partial-difference between each of the one or more first sub-regions and its corresponding second sub-region. The processing device 120a may determine the difference between the first local region and the second local region based on the one or more partial-differences (e.g., by averaging the one or more partial-differences). The larger the value of the local loss function is, the less similar the first mask region may be to the second mask region (i.e., the higher level of artifact that the first mask region has may be), and the worse the correction effect of the updated motion correction model may be. The smaller the value of the local loss function is, the more similar the first mask region may be to the second mask region (i.e., the lower level of artifact that the first mask region has may be), and the better the correction effect of the updated motion correction model may be. For instance, the processing device 120a may determine the value of the local loss function according to Equation (2) as follows:

$${Loss}_{local} = f ( M ( x ) * mask , GS * mask ) , \qquad ( 2 )$$

where mask denotes the mask, x denotes the sample image, M(⋅) denotes the updated preliminary model, M(x) denotes the estimated corrected image, GS denotes the gold standard image, M(x)*mask denotes the first mask region determined by multiplying the estimated corrected image and the mask according to which pixel values of the first local region in the estimated corrected image keep unchanged and pixel values of the remaining region in the estimated corrected image are changed to be 0, GS*mask denotes the second mask region determined by multiplying the gold standard image and the mask according to which pixel values of the second local region in the gold standard image keep unchanged and pixel values of the remaining region in the gold standard image are changed to be 0, and f(⋅) denotes a local loss function for determining a local loss between mask regions (e.g., the first mask region and the second mask region). In some embodiments, f(⋅) may include a mean square error (MSE) loss function, a mean absolute error (MAE) loss function, a structural similarity index (SSIM) loss function, or the like, or any combination thereof.

In some embodiments, the processing device 120a may determine (e.g., segment or extract) a first coronary artery from the estimated corrected image (e.g., using a coronary artery extraction algorithm (or model)). The coronary artery extraction algorithm (or model) may include any types of coronary artery extraction algorithms such as a 2D coronary artery extraction algorithm (or model) for determining a coronary artery from a 2D image, a 3D coronary artery extraction algorithm (or model) for determining a coronary artery from a 3D image. The processing device 120a may determine (e.g., segment or extract) a second coronary artery from the gold standard image (e.g., using the coronary artery extraction algorithm or model). The processing device 120a may determine the value of the dice related loss function based on the first coronary artery and the second coronary artery. The smaller the value of the dice related loss function is, the more the first coronary artery may overlap with the second coronary artery, and the higher accuracy of the determination (e.g., segmentation) of the first coronary artery may be. The larger the value of the local loss function is, the less the first coronary artery may overlap with the second coronary artery, and the lower accuracy of the determination (e.g., segmentation) of the first coronary artery may be. For example, the processing device 120a may determine the value of the dice related loss function according to Equation (3) as follows:

$${Loss}_{dice} = 1 - Dice ( F ( M ( x ) ) , F ( GS ) ) , \qquad ( 3 )$$

where F(⋅) denotes the coronary artery extraction algorithm, F(M(x)) denotes the first coronary artery, F(GS) denotes the second coronary artery, and Dice(⋅) denotes a dice loss function for determining a determination (e.g., segmentation) accuracy of the coronary artery (e.g., the first coronary artery). A value of the Dice (F(M(x)), F (GS)) may range from 0 to 1 (i.e., [0, 1]). In some embodiments, the processing device 120a may replace the dice loss function (i.e., Dice ( ) with a specific loss function in Equation (3) for determining the dice related loss function. The specific loss function may be similar to the dice loss function. Exemplary specific loss functions may include a sensitivity-specificity loss function, a loU loss function, a Tversky loss function, a generalized dice loss, a Focal Tversky loss function, or the like, or any combination thereof.

In some embodiments, the processing device 120a may determine the value of the global loss function based on the estimated corrected image and the gold standard image. The larger the value of the global loss function is, the less similar the estimated corrected image may be to the gold standard image (i.e., the higher level of artifact that the estimated corrected image has may be), and the worse the correction effect of the updated motion correction model may be. The smaller the value of the local loss function is, the more similar the estimated corrected image may be to the gold standard image (i.e., the lower level of artifact that the estimated corrected image has may be), and the better the correction effect of the updated motion correction model may be. For example, the processing device 120a may determine the value of the global loss function according to Equation (4) as follows:

$${Loss}_{global} = g ( M ( x ) , GS ) , \qquad ( 4 )$$

where g(⋅) denotes a global loss function for determining a global loss between the estimated corrected image and the gold standard image. g(⋅) may include a mean square error (MSE) loss function, a mean absolute error (MAE) loss function, a structural similarity index (SSIM) loss function, or the like, or any combination thereof. g(⋅) may be the same as or different from f(⋅). For example, the processing device 120a may determine a first value of the global loss function using the MSE loss function. The processing device 120a may determine a second value of the global loss function using the MAE loss function. The processing device 120a may determine the value of the global loss function based on the first value and the second value (e.g., by determining an average of the first value and the second value, or a weighted sum of the first value and the second value).

In some embodiments, the processing device 120a may perform a preprocessing operation on values of the one or more loss functions before determining the value of the combined loss function. The processing device 120a may determine the value of the combined loss function based on the preprocessed values of the one or more loss functions (e.g., by a weighted sum of the preprocessed values according to the weights of the one or more loss functions). The preprocessing operation may be configured to adjust the values of the one or more loss functions to a same order of magnitude. For example, if the combined loss function includes the local loss function, the dice related loss function, and the global loss function, the processing device 120a may enlarge at least one of the value of the local loss function or the value of the dice related loss function, such that the preprocessed value of the local loss function, the preprocessed value of the dice related loss function, and the value of the global loss function are in a same order of magnitude. As another example, the processing device 120a may reduce the value of the global dice loss function and/or enlarge at least one of the value of the local loss function and the value of the dice related loss function, such that the preprocessed value of the local loss function, the preprocessed value of the dice related loss function, and the preprocessed value of the global loss function are in a same order of magnitude. Further, the processing device 120a may determine the value of the combined loss function by a weighted sum of the preprocessed value of the local loss function, the preprocessed value of the dice related loss function, and the preprocessed value of the global loss function. In some embodiments, before determining the value of the combined loss function, the processing device 120a may perform a normalization operation of the preprocessed value of the preprocessed value of the local loss function, the preprocessed value of the dice related loss function, and the preprocessed value of the global loss function.

In some embodiments, the processing device 120a may determine whether the value of the combined loss function satisfies a termination condition. For example, the termination condition may be deemed satisfied if the value of the combined loss function is minimal or smaller than a threshold (e.g., a constant). As another example, the termination condition may be deemed satisfied if the value of the combined loss function converges. In some embodiments, convergence may be deemed to have occurred if, for example, the variation of values of combined loss functions in two or more consecutive iterations is equal to or smaller than a threshold (e.g., a constant). In some embodiments, the termination condition may be deemed satisfied if a certain count of iterations has been performed, or if a certain count of the plurality of training samples has been used.

In response to determining that the termination condition is not satisfied, process 600 may proceed to operation 640. In 640, the processing device 120a (e.g., the training module 420) may update, based on the value of the combined loss function, the updated preliminary model. The updated preliminary model determined in 640 may further be used in a next iteration. Merely by way of example, the processing device 120a may update parameter value(s) of the updated preliminary model based on the value of the combined loss function according to, for example, a back propagation through time (BPTT) algorithm. In some embodiments, the updated preliminary model may include a plurality of parameter values, and updating parameter value(s) of the updated preliminary model refers to updating at least a portion of the parameter values of the updated preliminary model.

In response to determining that the termination condition is satisfied, process 600 may proceed to operation 650. In 650, the processing device 120a (e.g., the training module 420) may designate, based on the value of the combined loss function, the updated preliminary model as the motion correction model. In other words, parameter values of the updated preliminary model may be designated as parameter values of the motion correction model.

It should be noted that the above description regarding the process 600 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the process 600 may be accomplished with one or more additional operations not described and/or without one or more of the operations discussed above. For example, the process 600 may include an additional operation for determining whether the termination condition is satisfied. In some embodiments, the value of the local loss function (or the dice related loss function) may be determined based on one or more different types of local loss functions (or one or more dice related loss functions), e.g., by determining a weighted sum of values of the one or more local loss functions (or dice related loss functions).

FIG. 7 is a flowchart illustrating an exemplary process for evaluating a correction effect of a correction algorithm according to some embodiments of the present disclosure. In some embodiments, process 700 may be executed by the medical imaging system 100. For example, the process 700 may be implemented as a set of instructions (e.g., an application) stored in a storage device (e.g., the storage device 150, the storage device 220, and/or the storage 390). In some embodiments, the processing device 120b (e.g., the processor 210 of the computing device 200, the CPU 340 of the mobile device 300, and/or one or more modules illustrated in FIG. 4B) may execute the set of instructions and may accordingly be directed to perform the process 700. The operations of the illustrated process presented below are intended to be illustrative. In some embodiments, the process 700 may be accomplished with one or more additional operations not described and/or without one or more of the operations discussed. Additionally, the order of the operations of process 700 illustrated in FIG. 7 and described below is not intended to be limiting.

In 710, the processing device 120b (e.g., the obtaining module 430) may correct an initial image using the correction algorithm to obtain a corrected image.

As used herein, the initial image may refer to an image of a subject (or a portion thereof) that has motion artifact(s) to be corrected. The subject (or a portion thereof) may undergo a motion during the acquisition of the initial image using a medical imaging device (e.g., the medical imaging device 110). For example, the subject may include the heart of a patient (e.g., a left and/or right ventricle of the heart), a blood vessel of the patient (e.g., a left and/or right coronary artery), a lung of the patient, etc. Accordingly, the initial image may include an image of the heart of a patient, an image of a lung of the patient, an image of a blood vessel of the patient, etc.

The correction algorithm may refer to an algorithm or model configured for motion correction of a medical image or raw data of the medical image. The correction algorithm may include any type of correction algorithm to be evaluated. Merely by way of example, the correction algorithm may include a motion vector field correction algorithm, a raw data correction algorithm, an artificial intelligence correction algorithm (e.g., a machine learning model for motion correction such as the motion correction model described in FIG. 5), or the like, or any combination thereof.

In 720, the processing device 120b (e.g., the obtaining module 430) may obtain a gold standard image corresponding to the initial image.

The gold standard image corresponding to the initial image may be with substantial removal of the motion artifact(s) from the initial image. For example, the gold standard image may have no motion artifact. As another example, a motion artifact in the gold standard image may be less than a preset level of artifact. In some embodiments, the processing device 120b may retrieve the gold standard image from one or more components of the medical imaging system 100 or an external storage device of the medical imaging system 100. Alternatively, the processing device 120b may generate the gold standard image by correcting the initial image using a preset correction algorithm.

In 730, the processing device 120b (e.g., the evaluation module 440) may evaluate the correction effect of the correction algorithm based on a combined loss function associated with the corrected image and the gold standard image.

As described in connection with FIGS. 5 and 6, the combined loss function may include one or more loss functions each of which corresponds to a specific weight. The one or more loss functions may include one or more local loss functions, a dice related loss function, a global loss function, or the like, or any combination thereof. For example, the combined loss function may include at least a local loss function associated with a first local region (e.g., a first mask region) of the corrected image and a second local region (e.g., a second mask region) of the gold standard image. The first local region and the second local region may be associated with a portion of the subject that has relatively obvious artifact(s) and/or a relatively large level of artifacts. For the corrected image associated with the heart of a patient, the first local region and the second local region may include a coronary artery.

In some embodiments, the processing device 120b may determine a value of the combined loss function based on values of the one or more loss functions. The processing device 120b may evaluate the correction effect of the correction algorithm based on the value of the combined loss function. For example, the smaller the value of the combined loss function is, the better the correction effect of the correction algorithm may be. Alternatively, the closer the value of the combined loss function to a preset value is, the better the correction effect of the correction algorithm may be. The preset value may be a default setting of the medical imaging system 100 or adjustable according to different situations. In some embodiments, the processing device 120b may map the value of the combined loss function to an evaluation value. In some embodiments, different values of the combined loss function may correspond to different evaluation values. The processing device 120b may evaluate the correction effect of the correction algorithm according to the evaluation value. Alternatively, the processing device 120b may directly output the evaluation value for a user (e.g., a doctor), and the user may evaluate, based on the evaluation value according to a preset rule, the correction effect of the correction algorithm. For example, the preset rule may include that the smaller the value of the combined loss function is, the larger the evaluation value may be, and the better the correction effect of the correction algorithm may be.

In some embodiments, the combined loss function may include the local loss function associated with the first local region and the second local region, a dice related loss function associated with a first coronary artery of the corrected image and a second coronary artery of the gold standard image, a global loss function associated with the corrected image and the gold standard image, or the like, or any combination thereof. The processing device 120b may determine the value of the combined loss function by a weighted sum of a value of the local loss function associated with the first local region and the second local region, a value of the dice related loss function associated with the first coronary artery and the second coronary artery, and a value of the global loss function. A first significance of the local loss function may be higher than a second significance of the dice related loss function. The second significance of the dice related loss function may be larger than a third significance of the global loss function. For instance, the processing device 120b may extract a centerline of the coronary artery from the gold standard image. The processing device 120b may determine a mask by performing an expansion operation on the centerline. The processing device 120b may determine the first local region of the corrected image based on the mask and the corrected image. The processing device 120b may determine the second local region of the gold standard image based on the mask and the gold standard image. The processing device 120b may determine the value of the local loss function based on a difference between the first local region and the second local region. As another example, the processing device 120b may determine (e.g., segment or extract) the first coronary artery from the corrected image (e.g., using a coronary artery extraction algorithm or model). The processing 120b may determine (e.g., segment or extract) the second coronary artery from the gold standard image. The processing device 120b may determine a value of the dice related loss function based on the first coronary artery and the second coronary artery. As still another example, the processing device 120b may determine the value of the global loss function based on the corrected image and the gold standard image. Further, the processing device 120b may determine the value of the combined loss function based on the value of the global loss function, the value of the dice related loss function, and the value of the global loss function. More descriptions regarding the determination of the combined loss function or the value thereof and/or the values of the one or more loss functions of the combined loss function may be found elsewhere in the present disclosure (e.g., operation 630 in FIG. 6 and the description thereof).

According to some embodiments of the present disclosure, the correction effect of the correction algorithm may be evaluated according to the combined loss function quantitatively, which improves the efficiency and accuracy of the evaluation of the correction effect.

In some embodiments, the processing device 120b may evaluate the correction effect of the correction algorithm based on the combined loss function and/or one or more additional loss functions. The additional loss function(s) may include a loss function whose value is positively related to the correction effect of the correction algorithm (i.e., the larger the value of the loss function is, the better the correction effect of the correction algorithm may be), such as a normalized circularity function, a positivity loss function, or a circularity loss function. The positivity loss function may be defined as Equation (5) as follows:

$${L}_{pos} = {\sum }_{{h}_{j} ∈ ROI} ( \{ \begin{matrix}0 , {h}_{j} > T \\ {( {h}_{j} - T )}^{2} , otherwise\end{matrix} ) , \qquad ( 5 )$$

where Lₚₒₛ denotes the positivity loss function, hⱼ denotes an intensity of jth pixel of a region of interest (ROI) (e.g., a vessel ROI such as a coronary artery) in the corrected image, and T denotes a threshold. The threshold may be defined as a myocardium intensity minus a standard deviation of the myocardium to identify shading artifacts while reducing sensitivity to noise. The shading artifacts may be assumed to have lower intensity than the myocardium. The myocardium intensity may be determined as a mean value of pixels surrounding the coronary artery. The range of Lₚₒₛ may be [0, infinity). The larger a value of the positivity loss function, the better the correction effect of the correction algorithm may be.

The circularity loss function may be defined as Equation (6) as follows:

$${L}_{circ} = \frac{4 π A}{{p}^{2}} , \qquad ( 6 )$$

where L_{circ} denotes the circularity loss function, p denotes a perimeter of a segmented vessel (e.g., a segmented coronary artery) of the corrected image, and A denotes an area of the segmented vessel. In some embodiments, the processing device 120b may segment the segmented vessel using a binary segmentation algorithm, and therefore the segmented vessel may also be referred to as a segmented binary vessel. The circularity of a perfect circle is equal to one, with non-circular shapes having circularity greater than one. Since A and p are measured on a pixelized image (e.g., the corrected image), a circularity value may be less than one in some cases due to discretization errors. The circularity values may be transformed to have a range of zero to one, with a value of zero indicating high deformation and a value of one indicating a perfect circle. Accordingly, a value of the circularity loss function may be [0, 1]. The larger the value of the circularity loss function is, the better the correction effect of the correction algorithm may be.

In some embodiments, the processing device 120b may evaluate the correction effect of the correction algorithm based on the value of the combined loss function and value(s) of the one or more additional loss functions. The smaller the value of the combined loss function is and the larger the value(s) of the one or more additional loss functions are, the better the correction effect of the correction algorithm may be.

It should be noted that the above description regarding the process 700 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added in and/or omitted from the process 700. For example, operation 730 may include two sub-operations one of which is for determining the value of the combined loss function and the other one of which is for evaluating the correction effect based on the value of the combined loss function. As another example, operation 710 may be omitted and the processing device 120b may obtain the corrected image from one or more components of the medical imaging system 100 as disclosed in the present disclosure. In some embodiments, the processing device 120b may select an optimal correction algorithm from multiple correction algorithms based on combined loss functions corresponding to the multiple correction algorithms. For example, the processing device 120b may correct the initial image using the multiple correction algorithms respectively to obtain multiple corrected images. For each of the multiple corrected images, the processing device 120b may determine a value of a combined loss function corresponding to one of the multiple correction algorithms based on the corrected image and the gold standard image. The processing device 120b may determine a minimum value of the combined loss function among the values of the multiple combined loss functions. The processing device 120b may determine a correction algorithm corresponding to a minimum value of the combined loss function as the optimal correction algorithm.

FIG. 8 is a flowchart illustrating an exemplary process for determining a combined loss function according to some embodiments of the present disclosure. In some embodiments, process 800 may be executed by the medical imaging system 100. For example, the process 800 may be implemented as a set of instructions (e.g., an application) stored in a storage device (e.g., the storage device 150, the storage device 220, and/or the storage 390). In some embodiments, the processing device 120a (e.g., the processor 210 of the computing device 200, the CPU 340 of the mobile device 300, and/or one or more modules illustrated in FIG. 4A) may execute the set of instructions and may accordingly be directed to perform the process 800. Alternatively, the process 800 may be performed by a computing device of a system of a vendor that provides and/or maintains such an optimizing model. The operations of the illustrated process presented below are intended to be illustrative. In some embodiments, the process 800 may be accomplished with one or more additional operations not described and/or without one or more of the operations discussed. Additionally, the order of the operations of process 800 is illustrated in FIG. 8 and described below is not intended to be limiting. In some embodiments, one or more operations of process 800 may be performed to achieve at least part of operation 520 as described in connection with FIG. 5 and/or operation 630 as described in connection with FIG. 6.

In 810, the processing device 120a (e.g., the obtaining module 410) may obtain a plurality of corrected images of an initial image.

The initial image refers to an image of a subject (or a portion thereof) that has motion artifact(s) to be corrected as described in operation 710 in FIG. 7. In some embodiments, the plurality of corrected images may have different degrees of motion artifacts with respect to the initial image.

In some embodiments, the plurality of corrected images may be previously stored in a storage device (e.g., the storage device 150, the storage device 220, the storage 390, or an external storage device) disclosed elsewhere in the present disclosure. The processing device 120a may obtain (e.g., retrieve) the plurality of corrected images from the storage device. Alternatively, the processing device 120a may obtain (e.g., determine) the plurality of corrected images. For example, the processing device 120a may determine the plurality of corrected images by using a plurality of correction algorithms or models on the initial image respectively. As another example, the processing device 120a may simulate the plurality of corrected images based on the initial image. As a further example, the processing device 120a may simulate the plurality of corrected images based on a gold standard image corresponding to the initial image (e.g., by adding different levels of artifacts to the gold standard image to obtain the plurality of corrected images).

In 820, the processing device 120a (e.g., the obtaining module 410) may obtain a gold standard image corresponding to the initial image.

The gold standard image refers to an image with substantial removal of the motion artifacts from the initial image as described in operation 510 in FIG. 5. In some embodiments, the gold standard image may be previously stored in a storage device (e.g., the storage device 150, the storage device 220, the storage 390, or an external storage device) of the present disclosure. The processing device 120a may obtain (e.g., retrieve) the gold standard image from the storage device. Alternatively, the processing device 120a may generate the gold standard image based on the initial image (e.g., using a traditional motion correction algorithm and/or an existing correction model).

In 830, the processing device 120a (e.g., the obtaining module 410) may determine the combined correction function based on the plurality of corrected images and the gold standard image.

As described in connection with FIGS. 5 and 6, the combined loss function may include one or more loss functions each of which corresponds a specific weight. As used herein, the determination of the combined correction function refers to determining and/or adjusting the weights of the one or more loss functions.

In some embodiments, the processing device 120a may determine a reference rank result by ranking the plurality of corrected images (e.g., manually by a user, or by comparing with the gold standard image). The processing device 120a may obtain an initial loss function (e.g., with initial weights of the one or more loss functions of the combined loss function). The processing device 120a may determine an evaluated rank result by ranking, based on the initial loss function and the gold standard image, the plurality of corrected images. For example, for each of the plurality of corrected images, the processing device 120a may determine a value of the initial loss function based on the corrected image and the gold standard image, which is similar to the determination of the value of the combined loss function based on the estimated corrected image and the gold standard image as described in operation 630. Further, the processing device 120a may determine the combined loss function by adjusting the initial loss function (e.g., adjusting weights of the initial loss function) until an updated evaluated rank result substantially coincides with the reference rank result.

For example, the processing device 120a may determine whether the evaluated rank result coincides with the reference rank result. In response to determining that the evaluated rank result coincides with the reference rank result, the processing device 120a may designate the current weights of the initial loss function as the weights of the combined loss function. In response to determining that the evaluated rank result does not coincide with the reference rank result, the processing device 120a may update the weights of the initial loss function until the updated evaluated rank result substantially coincides with the reference rank result. The processing device 120a may then designate final updated initial weights as the weights of the combined loss function.

It should be noted that the above description regarding the process 800 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added in and/or omitted from the process 800. For example, operation 830 may include two sub-operations one of which is for ranking the plurality of corrected images and another one of which is for determining the combined loss function based on the reference rank result. As another example, the process 800 may include a storing operation for storing the determined combined loss function for subsequent processing.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction performing system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system for motion correction, comprising:
at least one storage device including a set of instructions; and
at least one processor configured to communicate with the at least one storage device, wherein when executing the set of instructions, the at least one processor is configured to direct the system to perform operations including:
obtaining a plurality of training samples each of which includes a sample image of a heart and a gold standard image of the heart, wherein the sample image has a motion artifact and the gold standard image is with substantial removal of the motion artifact;
determining a motion correction model by training, based on the plurality of training samples according to a combined loss function, a preliminary model, wherein the combined loss function includes at least a local loss function.

2. The system of claim 1, wherein the determining a motion correction model by training, based on the plurality of training samples according to a combined loss function, a preliminary model includes:
training the preliminary model according to an iterative operation including one or more iterations, and in at least one of the one or more iterations, the at least one processor is configured to direct the system to perform the operations further including:
obtaining an updated preliminary model generated in a previous iteration;
for the each of the plurality of training samples,
generating, based on the sample image, an estimated corrected image using the updated preliminary model;
determining a value of the combined loss function based on the estimated corrected image and the gold standard image; and
updating, based on the value of the combined loss function, the updated preliminary model, or
designating, based on the value of the combined loss function, the updated preliminary model as the motion correction model.

3. The system of claim 2, wherein the at least one processor is configured to direct the system to perform the operations further including:
extracting a centerline of a coronary artery from the gold standard image;
determining a mask by performing an expansion operation on the centerline; and
determining a value of the local loss function based on the mask, the estimated corrected image, and the gold standard image.

4-14. (canceled)

15. A method for motion correction, which is implemented on a computing device including at least one processor and at least one storage device, comprising:
obtaining a plurality of training samples each of which includes a sample image of a heart and a gold standard image of the heart, wherein the sample image has a motion artifact and the gold standard image is with substantial removal of the motion artifact;
determining a motion correction model by training, based on the plurality of training samples according to a combined loss function, a preliminary model, wherein the combined loss function includes at least a local loss function.

16. The method of claim 15, wherein the determining a motion correction model by training, based on the plurality of training samples according to a combined loss function, a preliminary model includes:
training the preliminary model according to an iterative operation including one or more iterations, and in at least one of the one or more iterations, the method further includes:
obtaining an updated preliminary model generated in a previous iteration;
for the each of the plurality of training samples,
generating, based on the sample image, an estimated corrected image using the updated preliminary model;
determining a value of the combined loss function based on the estimated corrected image and the gold standard image; and
updating, based on the value of the combined loss function, the updated preliminary model, or
designating, based on the value of the combined loss function, the updated preliminary model as the motion correction model.

17. The method of claim 16, further comprising:
extracting a centerline of a coronary artery from the gold standard image;
determining a mask by performing an expansion operation on the centerline; and
determining a value of the local loss function based on the mask, the estimated corrected image, and the gold standard image.

18. The method of claim 17, wherein the determining a value of the local loss function based on the mask, the estimated corrected image, and the gold standard image includes:
determining, in the estimated corrected image, a first local region corresponding to the coronary artery based on the mask and the estimated corrected image;
determining, in the gold standard image, a second local region corresponding to the coronary artery based on the mask and the gold standard image; and
determining the value of the local loss function based on a difference between the first local region and the second local region.

19. The method of claim 16, wherein the combined loss function further includes a dice related loss function.

20. The method of claim 19, further comprising:
determining a first coronary artery from the estimated corrected image;
determining a second coronary artery from the gold standard image; and
determining a value of the dice related loss function based on the first coronary artery and the second coronary artery.

21. The method of claim 19, wherein the combined loss function further includes a global loss function.

22. The method of claim 21, further comprising:
determining a value of the global loss function based on the estimated corrected image and the gold standard image.

23. The method of claim 21, further comprising:
determining a value of the combined loss function by a weighted sum of a value of the local loss function, a value of the dice related loss function, and a value of the global loss function.

24. The method of claim 23, wherein a first significance of the local loss function is higher than a second significance of the dice related loss function, and the second significance of the dice related loss function is higher than a third significance of the global loss function.

25. The method of claim 23, wherein the determining a value of the combined loss function by a weighted sum of a value of the local loss function, a value of the dice related loss function, and a value of the global loss function includes:
performing a preprocessing operation on the value of the local loss function, the value of the dice related loss function, and the value of the global loss function respectively, such that the preprocessed value of the local loss function, the preprocessed value of the dice function, and the preprocessed value of the global loss function are in a same order of magnitude; and
determining the value of the combined loss function by a weighted sum of the preprocessed value of the local loss function, the preprocessed value of the dice related loss function, and the preprocessed value of the global loss function.

26. The method of claim 25, wherein the preprocessing operation includes enlarging at least one of the value of the local loss function or the value of the dice related loss function.

27. The method of claim 15, further comprising:
obtaining a plurality of corrected images of an initial image;
obtaining a gold standard image corresponding to the initial image; and
determining the combined loss function based on the plurality of corrected images and the gold standard image.

28. The method of claim 27, wherein the determining the combined loss function based on the plurality of corrected images and the gold standard image includes:
determining a reference rank result by ranking the plurality of corrected images;
obtaining an initial loss function;
determining an evaluated rank result by ranking, based on the initial loss function and the gold standard image, the plurality of corrected images; and
determining the combined loss function by adjusting the initial loss function until an updated evaluated rank result substantially coincides with the reference rank result.

29-30. (canceled)

31. A system for correction effect evaluation, comprising:
at least one storage device including a set of instructions; and
at least one processor configured to communicate with the at least one storage device, wherein when executing the set of instructions, the at least one processor is configured to direct the system to perform operations including:
correcting an initial image using a correction algorithm to obtain a corrected image;
obtaining a gold standard image corresponding to the initial image;
evaluating a correction effect of the correction algorithm based on a combined loss function associated with the corrected image and the gold standard image, wherein the combined loss function includes at least a local loss function associated with a first local region of the corrected image and a second local region of the gold standard image.

32. The system of claim 31, wherein the first local region and the second local region includes a coronary artery.

33. The system of claim 32, wherein the at least one processor is configured to direct the system to perform the operations further including:
extracting a centerline of the coronary artery from the gold standard image;
determining a mask by performing an expansion operation on the centerline;
determining the first local region of the corrected image based on the mask and the corrected image;
determining the second local region of the gold standard image based on the mask and the gold standard image; and
determining a value of the local loss function based on a difference between the first local region and the second local region.

34-56. (canceled)
